(19) United States
(12) Patent Application Publication
(10) Pub. No.: US 2013/0088580 A1
(43) Pub. Date: Apr. 11, 2013

(54) CAMERA BODY, INTERCHANGEABLE LENS UNIT, IMAGE CAPTURING DEVICE, METHOD FOR CONTROLLING CAMERA BODY, PROGRAM, AND RECORDING MEDIUM ON WHICH PROGRAM IS RECORDED

(71) Applicants: Takahiro Ikeda, Osaka (JP); Mitsuyoshi Okamoto, Osaka (JP); Hiroshi Ueda, Osaka (JP)

(72) Inventors: Takahiro Ikeda, Osaka (JP); Mitsuyoshi Okamoto, Osaka (JP); Hiroshi Ueda, Osaka (JP)

(73) Assignee: PANASONIC CORPORATION, Osaka (JP)

(21) Appl. No.: 13/702,621

(22) PCT Filed: Feb. 8, 2011
(86) PCT No.: PCT/JP2011/000693

§ 371 Date: Dec. 7, 2012

(30) Foreign Application Priority Data
Jul. 27, 2010 (JP) 2010-168352

(51) Int. Cl. H04N 13/02; H04N 5/217

(52) U.S. Cl. CPC H04N 13/0203; H04N 5/217
USPC 348/49; 348/241

(57) ABSTRACT

A camera body (100) comprises a body mount (150), a CMOS image sensor (110), and a characteristic information acquisition component 143. The body mount (150) is provided so as to allow the mounting of an interchangeable lens unit (200). The CMOS image sensor (110) converts an optical image into an electrical signal. The characteristic information acquisition component (143) makes it possible to acquire an extraction position correction amount (L11) from the interchangeable lens unit (200) mounted to the body mount (150). The extraction position correction amount (L11) indicates the distance from a center (ICL) and a center (ICR) corresponding to when the convergence point distance is infinity, to an extraction center (ACL2) and an extraction center (ACR2) corresponding to a recommended convergence point distance (L10) of the interchangeable lens unit (200).

### TECHNICAL FIELD

The technology disclosed herein relates to a camera body to which an interchangeable lens unit can be mounted, to an interchangeable lens unit, and to an imaging device. Also, the technology disclosed herein relates to a method for controlling a camera body, to a program, and to a recording medium to which a program is recorded.

### BACKGROUND ART

An interchangeable lens type of digital camera is a known imaging device. An interchangeable lens type of digital camera comprises an interchangeable lens unit and a camera body. This camera body has an imaging element such as a CCD (charge coupled device) image sensor or a CMOS (complementary metal oxide semiconductor) image sensor. The imaging element converts an optical image formed by the interchangeable lens unit into an image signal. This allows image data about a subject to be acquired.

### CITATION LIST

### Patent Literature

Patent Literature 1: Japanese Laid-Open Patent Application H7-274214

### SUMMARY

### Technical Problem

Development of so-called three-dimensional displays has been underway for some years now. This has been accompanied by the development of digital cameras that produce what is known as stereo image data (image data for three-dimensional display use, including a left-eye image and a right-eye image).

However, a three-dimensional imaging-use optical system (hereinafter also referred to as a three-dimensional optical system) has to be used to produce a stereo image having parallax.

In view of this, a video camera has been proposed which automatically switches between two-dimensional imaging mode and three-dimensional imaging mode based on whether or not an adapter for three-dimensional imaging has been mounted (see Patent Literature 1, for example).

Meanwhile, there is an optimal imaging distance (the distance from the camera to the convergence point) for each three-dimensional optical system, but if the recommended imaging distance is different, the position of the extraction region for left-eye image data and right-eye image data will vary from one optical system to the next.

However, with the video camera discussed in Patent Literature 1, a three-dimensional imaging-use optical system is merely mounted on the front side of an ordinary optical system, so even if imaging is performed at the imaging distance recommended for the optical system that is mounted, that does not mean that the optimal extraction region can be set in extracting left-eye image data and right-eye image data. Therefore, there may be situations in which a stereo image that is suited to stereoscopic view cannot be acquired.

It is an object of the present invention to provide a camera body and an interchangeable lens unit with which a better stereo image can be acquired.

### Solution to Problem

The camera body pertaining to a first aspect comprises a body mount, an imaging element, and a correction information acquisition component. The body mount is provided so as to allow the mounting of an interchangeable lens unit. The imaging element converts an optical image into an image signal. The correction information acquisition component allows an extraction position correction amount to be acquired from the interchangeable lens unit that is mounted to the body mount. The extraction position correction amount indicates the distance on the imaging element from a reference extraction position corresponding to when the convergence point distance is infinity, to a recommended extraction position corresponding to the recommended convergence point distance of the interchangeable lens unit mounted to the body mount.

With this camera body, an extraction position correction amount is acquired by the correction information acquisition component from the interchangeable lens unit mounted to the body mount. Accordingly, the camera body can ascertain the amount of deviation from a reference extraction position corresponding to when the convergence point distance is infinity, to a recommended extraction position corresponding to the recommended convergence point distance of the interchangeable lens unit, and a better stereo image can be acquired.

The interchangeable lens unit pertaining to a second aspect comprises a three-dimensional optical system and a correction information storage component. The three-dimensional optical system forms an optical image for a stereoscopic view of a subject. The correction information storage component stores an extraction position correction amount. The extraction position correction amount indicates the distance on the imaging element from a reference extraction position corresponding to when the convergence point distance is infinity, to a recommended extraction position corresponding to the recommended convergence point distance of the interchangeable lens unit.

With this interchangeable lens unit, since the correction information storage component stores an extraction position correction amount, the camera body can ascertain the amount of deviation from a reference extraction position corresponding to when the convergence point distance is infinity, to a recommended extraction position corresponding to the recommended convergence point distance of the interchangeable lens unit, and a better stereo image can be acquired.

The control method pertaining to a third aspect is a method for controlling a camera body that produces image data based on an optical image formed by an interchangeable lens unit, comprising a step of acquiring, from an interchangeable lens unit mounted to a body mount, an extraction position correction amount that indicates the distance on an imaging element from a reference extraction position corresponding to when the convergence point distance is infinity, to a recommended extraction position corresponding to the recommended convergence point distance of the interchangeable lens unit.

The program pertaining to a fourth aspect causes a computer to execute a correction information acquisition function for acquiring, from an interchangeable lens unit, an extraction position correction amount that indicates the distance on an imaging element from a reference extraction position corresponding to when the convergence point distance is infinity, to a recommended extraction position corresponding to the recommended convergence point distance of the interchangeable lens unit.

The recording medium pertaining to a fifth aspect is a recording medium that can be read by a computer, with which a computer is made to execute a correction information acquisition function for acquiring, from an interchangeable lens unit, an extraction position correction amount that indicates the distance on an imaging element from a reference extraction position corresponding to when the convergence point distance is infinity, to a recommended extraction position corresponding to the recommended convergence point distance of the interchangeable lens unit.

### Advantageous Effects

With the camera body and interchangeable lens unit discussed above, a better stereo image can be acquired. Also, a better stereo image can be acquired with an imaging device having the above-mentioned camera body or interchangeable lens unit. Furthermore, with the above-mentioned control method, program, and recording medium to which a program is recorded, a better stereo image can be acquired using a camera body.

### BRIEF DESCRIPTION OF DRAWINGS

FIG. 1 is an oblique view of a digital camera 1;

FIG. 2 is an oblique view of a camera body 100;

FIG. 3 is a rear view of the camera body 100;

FIG. 4 is a simplified block diagram of the digital camera 1;

FIG. 5 is a simplified block diagram of an interchangeable lens unit 200;

FIG. 6 is a simplified block diagram of the camera body 100;

FIG. 7A is an example of the configuration of lens identification information F1, FIG. 7B is an example of the configuration of lens identification information F2, and FIG. 7C is an example of the configuration of lens identification information F3;

FIG. 8A is a time chart between a camera body and an interchangeable lens unit when the camera body is not compatible with three-dimensional imaging, and FIG. 8B is a time chart between a camera body and an interchangeable lens unit when the camera body and the interchangeable lens unit are compatible with three-dimensional imaging);

FIG. 9 is a diagram illustrating various parameters;

FIG. 10 is a diagram illustrating various parameters;

FIG. 11 is a flowchart of when the power is on;

FIG. 12 is a flowchart of when the power is on; and

FIG. 13 is a flowchart of during imaging.

### DESCRIPTION OF EMBODIMENTS

Configuration of Digital Camera

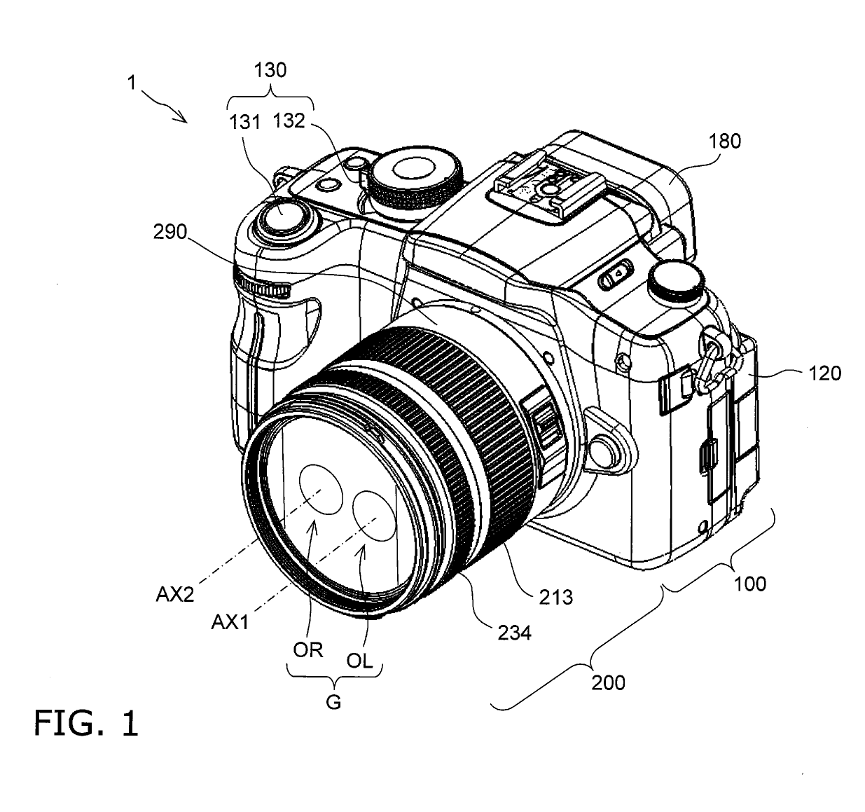

The digital camera 1 is an imaging device capable of three-dimensional imaging, and is an interchangeable lens type of digital camera. As shown in FIGS. 1 to 3, the digital camera 1 comprises an interchangeable lens unit 200 and a camera body 100 that allows the interchangeable lens unit 200 to be mounted. The interchangeable lens unit 200 is a lens unit that is compatible with three-dimensional imaging, and forms optical images of a subject (a left-eye optical image and a right-eye optical image). The camera body 100 is compatible with both two-dimensional imaging and three-dimensional imaging, and produces image data based on the optical image formed by the interchangeable lens unit 200. In addition to the interchangeable lens unit 200 that is compatible with three-dimensional imaging, an interchangeable lens unit that is not compatible with three-dimensional imaging can also be attached to the camera body 100. That is, the camera body 100 is compatible with both two-dimensional imaging and three-dimensional imaging.

For the sake of description, the subject side of the digital camera 1 will be called the front, the opposite side from the subject will be called the back or rear, the vertically upper side when the digital camera 1 is in its normal orientation (hereinafter also referred to as landscape orientation) as the top, and the vertically lower side as the bottom.

1: Configuration of Interchangeable Lens Unit

The interchangeable lens unit 200 is a lens unit that is compatible with three-dimensional imaging. The interchangeable lens unit 200 in this embodiment makes use of a side-by-side imaging system with which two optical images are formed on a single imaging element by a pair of left and right optical systems.

As shown in FIGS. 1 to 4, the interchangeable lens unit 200 has a three-dimensional optical system G, a first drive unit 271, a second drive unit 272, a shake amount detecting sensor 275, and a lens controller 240. The interchangeable lens unit 200 further has a lens mount 250, a lens barrel 290, a zoom ring 213, and a focus ring 234. In the mounting of the interchangeable lens unit 200 to the camera body 100, the lens mount 250 is attached to a body mount 150 (discussed below) of the camera body 100. As shown in FIG. 1, the zoom ring 213 and the focus ring 234 are rotatably provided to the outer part of the lens barrel 290.

(1) Three-Dimensional Optical System G

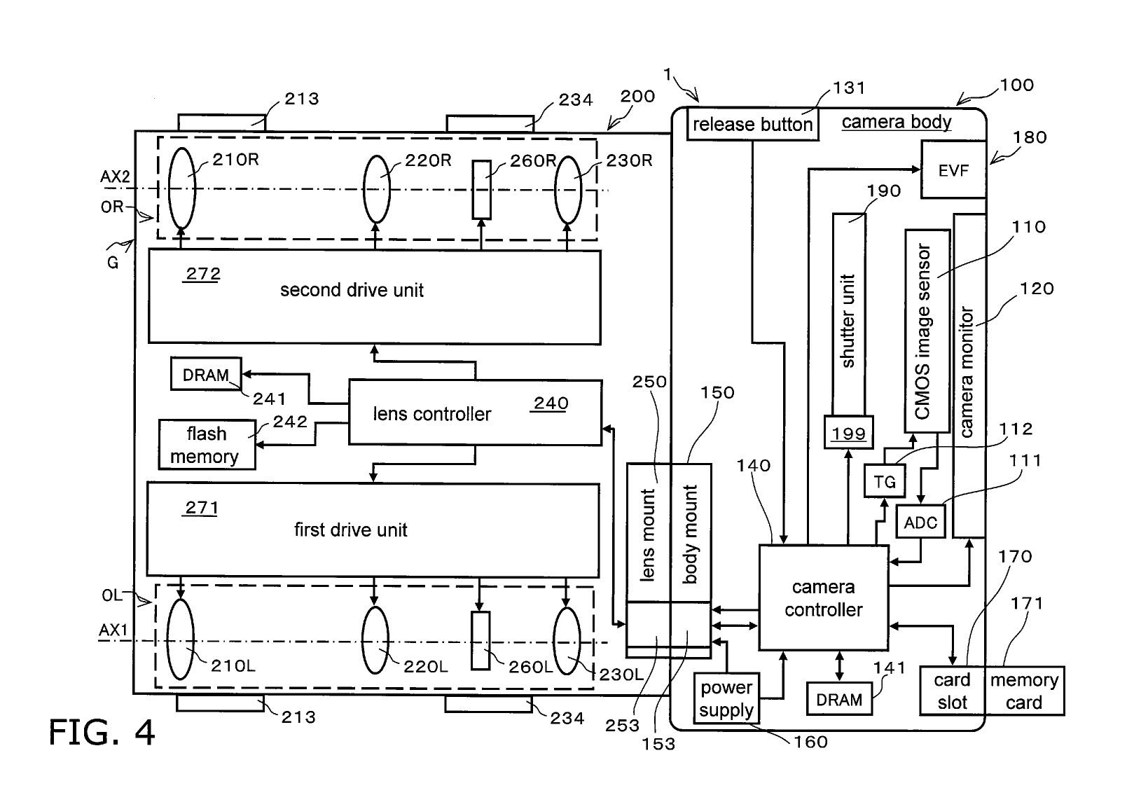

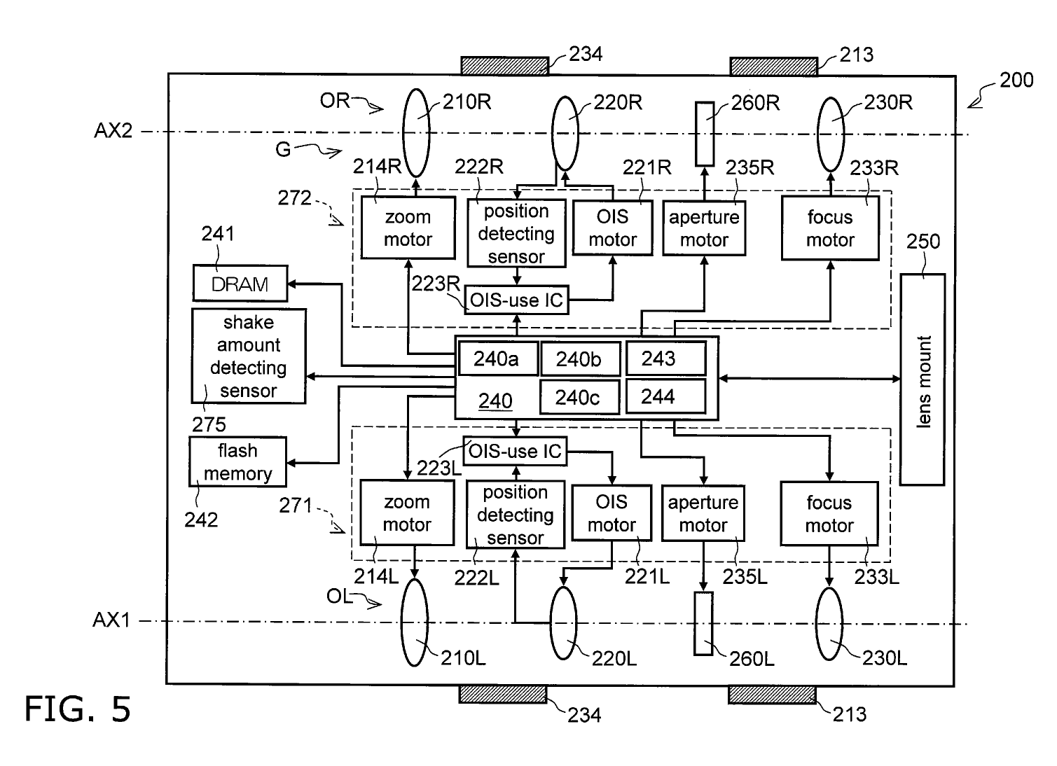

As shown in FIGS. 4 and 5, the three-dimensional optical system G is an optical system compatible with side-by-side imaging, and has a left-eye optical system OL and a right-eye optical system OR. The left-eye optical system OL and the right-eye optical system OR are disposed to the left and right of each other. Here, “left-eye optical system” refers to an optical system corresponding to a left-side perspective, and more specifically refers to an optical system in which the optical element disposed closest to the subject (the front side) is disposed on the left side facing the subject. Similarly, a “right-eye optical system” refers to an optical system corresponding to a right-side perspective, and more specifically refers to an optical system in which the optical element disposed closest to the subject (the front side) is disposed on the right side facing the subject.

The left-eye optical system OL is an optical system used to capture an image of a subject from a left-side perspective facing the subject, and includes a zoom lens 210L, an OIS lens 220L, an aperture unit 260L, and a focus lens 230L. The left-eye optical system OL has a first optical axis AX1, and is housed inside the lens barrel 290 in a state of being side by side with the right-eye optical system OR.

The zoom lens 210L is used to change the focal distance of the left-eye optical system OL, and is disposed movably in a direction parallel to the first optical axis AX1. The zoom lens 210L is made up of one or more lenses. The zoom lens 210L is driven by a zoom motor 214L (discussed below) of the first drive unit 271. The focal distance of the left-eye optical system OL can be adjusted by driving the zoom lens 210L in a direction parallel to the first optical axis AX1.

The OIS lens 220L is used to suppress displacement of the optical image formed by the left-eye optical system OL with respect to a CMOS image sensor 110 (discussed below). The OIS lens 220L is made up of one or more lenses. An OIS motor 221L drives the OIS lens 220L based on a control signal sent from an OIS-use IC 223L so that the OIS lens 220L moves within a plane perpendicular to the first optical axis AX1. The OIS motor 221L can be, for example, a magnet (not shown) and a flat coil (not shown). The position of the OIS lens 220L is detected by a position detecting sensor 222L (discussed below) of the first drive unit 271.

An optical system is employed as the blur correction system in this embodiment, but the blur correction system may instead be an electronic system in which image data produced by the CMOS image sensor 110 is subjected to correction processing, or a sensor shift system in which an imaging element such as the CMOS image sensor 110 is driven within a plane that is perpendicular to the first optical axis AX1.

The aperture unit 260L adjusts the amount of light that passes through the left-eye optical system OL. The aperture unit 260L has a plurality of aperture vanes (not shown). The aperture vanes are driven by an aperture motor 235L (discussed below) of the first drive unit 271. A camera controller 140 (discussed below) controls the aperture motor 235L.

The focus lens 230L is used to adjust the subject distance (also called the object distance) of the left-eye optical system OL, and is disposed movably in a direction parallel to the first optical axis AX1. The focus lens 230L is driven by a focus motor 233L (discussed below) of the first drive unit 271. The focus lens 230L is made up of one or more lenses.

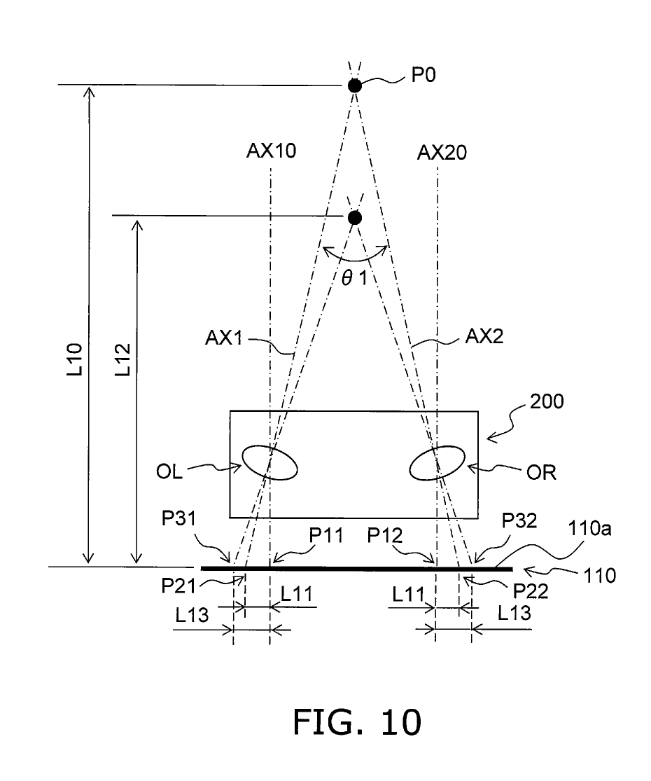

The right-eye optical system OR is an optical system used to capture an image of a subject from a right-side perspective facing the subject, and includes a zoom lens 210R, an OIS lens 220R, an aperture unit 260R, and a focus lens 230R. The right-eye optical system OR has a second optical axis AX2, and is housed inside the lens barrel 290 in a state of being side by side with the left-eye optical system OL. The angle formed by the first optical axis AX1 and the second optical axis AX2 (angle of convergence) is referred to as the angle θ1 shown in FIG. 10.

The zoom lens 210R is used to change the focal distance of the right-eye optical system OR, and is disposed movably in a direction parallel with the second optical axis AX2. The zoom lens 210R is made up of one or more lenses. The zoom lens 210R is driven by a zoom motor 214R (discussed below) of the second drive unit 272. The focal distance of the right-eye optical system OR can be adjusted by driving the zoom lens 210R in a direction parallel to the second optical axis AX2. The drive of the zoom lens 210R is synchronized with the drive of the zoom lens 210L. Therefore, the focal distance of the right-eye optical system OR is the same as the focal distance of the left-eye optical system OL.

The OIS lens 220R is used to suppress displacement of the optical image formed by the right-eye optical system OR with respect to the CMOS image sensor 110. The OIS lens 220R is made up of one or more lenses. An OIS motor 221R drives the OIS lens 220R based on a control signal sent from an OIS-use IC 223R so that the OIS lens 220R moves within a plane perpendicular to the second optical axis AX2. The OIS motor 221R can be, for example, a magnet (not shown) and a flat coil (not shown). The position of the OIS lens 220R is detected by a position detecting sensor 222R (discussed below) of the second drive unit 272.

An optical system is employed as the blur correction system in this embodiment, but the blur correction system may instead be an electronic system in which image data produced by the CMOS image sensor 110 is subjected to correction processing, or a sensor shift system in which an imaging element such as the CMOS image sensor 110 is driven within a plane that is perpendicular to the second optical axis AX2.

The aperture unit 260R adjusts the amount of light that passes through the right-eye optical system OR. The aperture unit 260R has a plurality of aperture vanes (not shown). The aperture vanes are driven by an aperture motor 235R (discussed below) of the second drive unit 272. The camera controller 140 controls the aperture motor 235R. The drive of the aperture unit 260R is synchronized with the drive of the aperture unit 260L. Therefore, the aperture value of the right-eye optical system OR is the same as the aperture value of the left-eye optical system OL.

The focus lens 230R is used to adjust the subject distance (also called the object distance) of the right-eye optical system OR, and is disposed movably in a direction parallel to the second optical axis AX2. The focus lens 230R is driven by a focus motor 233R (discussed below) of the second drive unit 272. The focus lens 230R is made up of one or more lenses.

(2) First Drive Unit 271

The first drive unit 271 is provided to adjust the state of the left-eye optical system OL, and as shown in FIG. 5, has the zoom motor 214L, the OIS motor 221L, the position detecting sensor 222L, the OIS-use IC 223L, the aperture motor 235L, and the focus motor 233L.

The zoom motor 214L drives the zoom lens 210L. The zoom motor 214L is controlled by the lens controller 240.

The OIS motor 221L drives the OIS lens 220L. The position detecting sensor 222L is a sensor for detecting the position of the OIS lens 220L. The position detecting sensor 222L is a Hall element, for example, and is disposed near the magnet of the OIS motor 221L. The OIS-use IC 223L controls the OIS motor 221L based on the detection result of the position detecting sensor 222L and the detection result of the shake amount detecting sensor 275. The OIS-use IC 223L acquires the detection result of the shake amount detecting sensor 275 from the lens controller 240. Also, the OIS-use IC 223L sends the lens controller 240 a signal indicating the position of the OIS lens 220L, at a specific period.

The aperture motor 235L drives the aperture unit 260L. The aperture motor 235L is controlled by the lens controller 240.

The focus motor 233L drives the focus lens 230L. The focus motor 233L is controlled by the lens controller 240. The lens controller 240 also controls the focus motor 233R, and synchronizes the focus motor 233L and the focus motor 233R. Consequently, the subject distance of the left-eye optical system OL is the same as the subject distance of the right-eye optical system OR. Examples of the focus motor 233L include a DC motor, a stepping motor, a servo motor, and an ultrasonic motor.

(3) Second Drive Unit 272

The second drive unit 272 is provided to adjust the state of the right-eye optical system OR, and as shown in FIG. 5, has the zoom motor 214R, the OIS motor 221R, the position detecting sensor 222R, the OIS-use IC 223R, the aperture motor 235R, and the focus motor 233R.

The zoom motor 214R drives the zoom lens 210R. The zoom motor 214R is controlled by the lens controller 240.

The OIS motor 221R drives the OIS lens 220R. The position detecting sensor 222R is a sensor for detecting the position of the OIS lens 220R. The position detecting sensor 222R is a Hall element, for example, and is disposed near the magnet of the OIS motor 221R. The OIS-use IC 223R controls the OIS motor 221R based on the detection result of the position detecting sensor 222R and the detection result of the shake amount detecting sensor 275. The OIS-use IC 223R acquires the detection result of the shake amount detecting sensor 275 from the lens controller 240. Also, the OIS-use IC 223R sends the lens controller 240 a signal indicating the position of the OIS lens 220R, at a specific period.

The aperture motor 235R drives the aperture unit 260R. The aperture motor 235R is controlled by the lens controller 240.

The focus motor 233R drives the focus lens 230R. The focus motor 233R is controlled by the lens controller 240. The lens controller 240 synchronizes the focus motor 233L and the focus motor 233R. Consequently, the subject distance of the left-eye optical system OL is the same as the subject distance of the right-eye optical system OR. Examples of the focus motor 233R include a DC motor, a stepping motor, a servo motor, and an ultrasonic motor.

(4) Lens Controller 240

The lens controller 240 controls the various components of the interchangeable lens unit 200 (such as the first drive unit 271 and the second drive unit 272) based on control signals sent from the camera controller 140. The lens controller 240 sends and receives signals to and from the camera controller 140 via the lens mount 250 and the body mount 150. During control, the lens controller 240 uses a DRAM 241 as a working memory.

The lens controller 240 has a CPU (central processing unit) 240a, a ROM (read only memory) 240b, and a RAM (random access memory) 240c, and can perform various functions by reading programs stored in the ROM 240b into the CPU 240a.

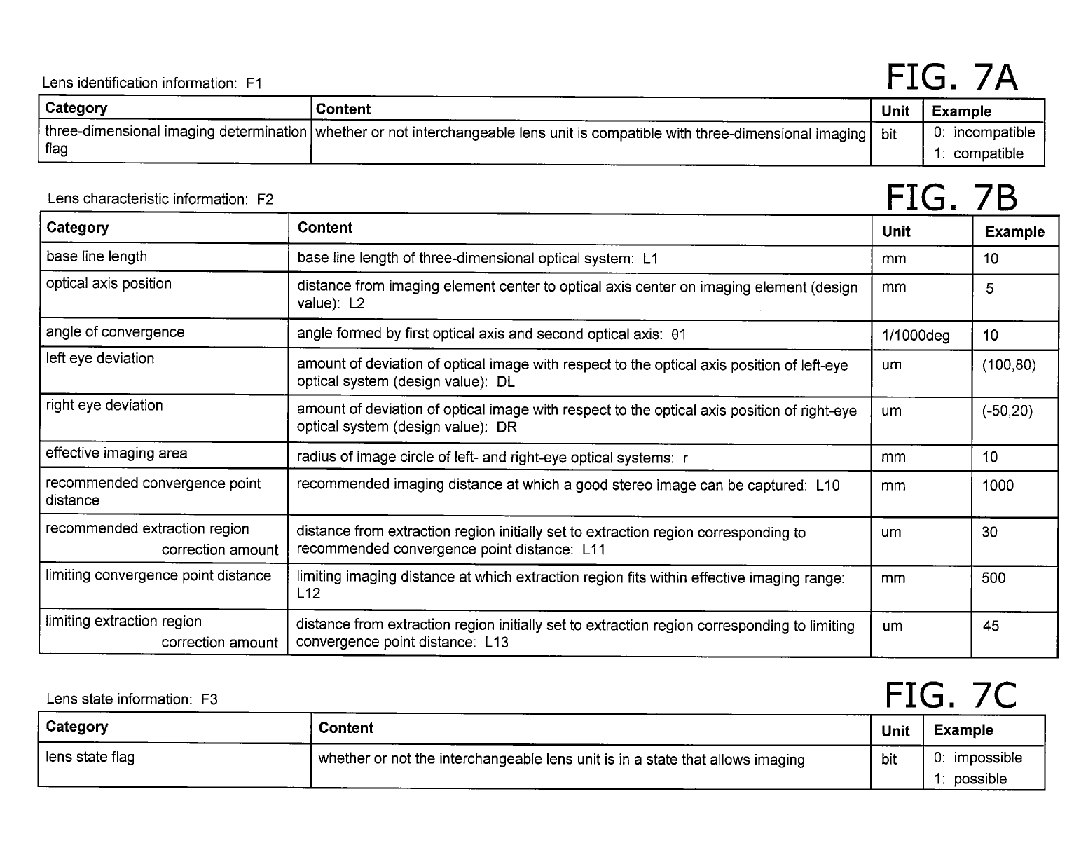

Also, a flash memory 242 (an example of a correction information storage component, and an example of an identification information storage component) stores parameters or programs used in control by the lens controller 240. For example, in the flash memory 242 are pre-stored lens identification information F1 (see FIG. 7A) indicating that the interchangeable lens unit 200 is compatible with three-dimensional imaging, and lens characteristic information F2 (see FIG. 7B) that includes flags and parameters indicating the characteristics of the three-dimensional optical system G. Lens state information F3 (see FIG. 7C) indicating whether or not the interchangeable lens unit 200 is in a state that allows imaging is held in the RAM 240c, for example.

The lens identification information F1, lens characteristic information F2, and lens state information F3 will now be described.

Lens Identification Information F1

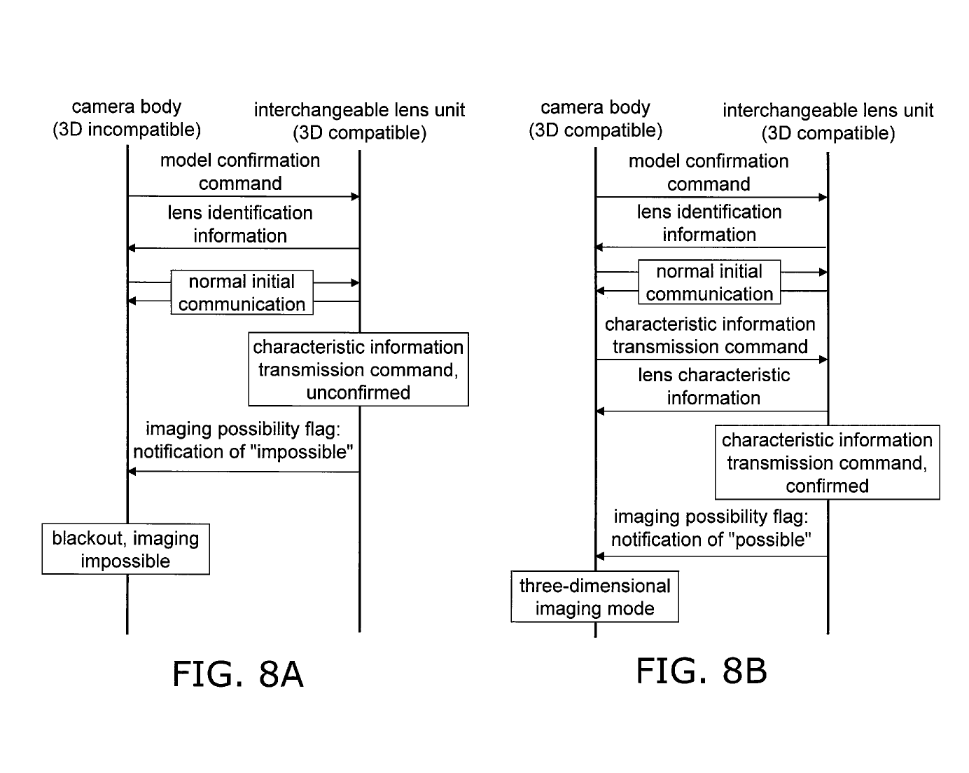

The lens identification information F1 is information indicating whether or not the interchangeable lens unit is compatible with three-dimensional imaging, and is stored ahead of time in the flash memory 242, for example. As shown in FIG. 7A, the lens identification information F1 is a three-dimensional imaging determination flag stored at a specific address in the flash memory 242. As shown in FIGS. 8A and 8B, a three-dimensional imaging determination flag is sent from the interchangeable lens unit to the camera body in the initial communication performed between the camera body and the interchangeable lens unit when the power is turned on or when the interchangeable lens unit is mounted to the camera body.

If a three-dimensional imaging determination flag has been raised, that interchangeable lens unit is compatible with three-dimensional imaging, but if a three-dimensional imaging determination flag has not been raised, that interchangeable lens unit is not compatible with three-dimensional imaging. A region not used for an ordinary interchangeable lens unit that is not compatible with three-dimensional imaging is used for the address of the three-dimensional imaging determination flag. Consequently, with an interchangeable lens unit that is not compatible with three-dimensional imaging, a state may result in which a three-dimensional imaging determination flag is not raised even though no setting of a three-dimensional imaging determination flag has been performed.

Lens Characteristic Information F2

The lens characteristic information F2 is data indicating the characteristics of the optical system of the interchangeable lens unit, and includes the following parameters and flags, as shown in FIG. 7B.

(A) Base Line Length

Base Line Length L1 of the Stereo Optical System (G)

(B) Optical Axis Position

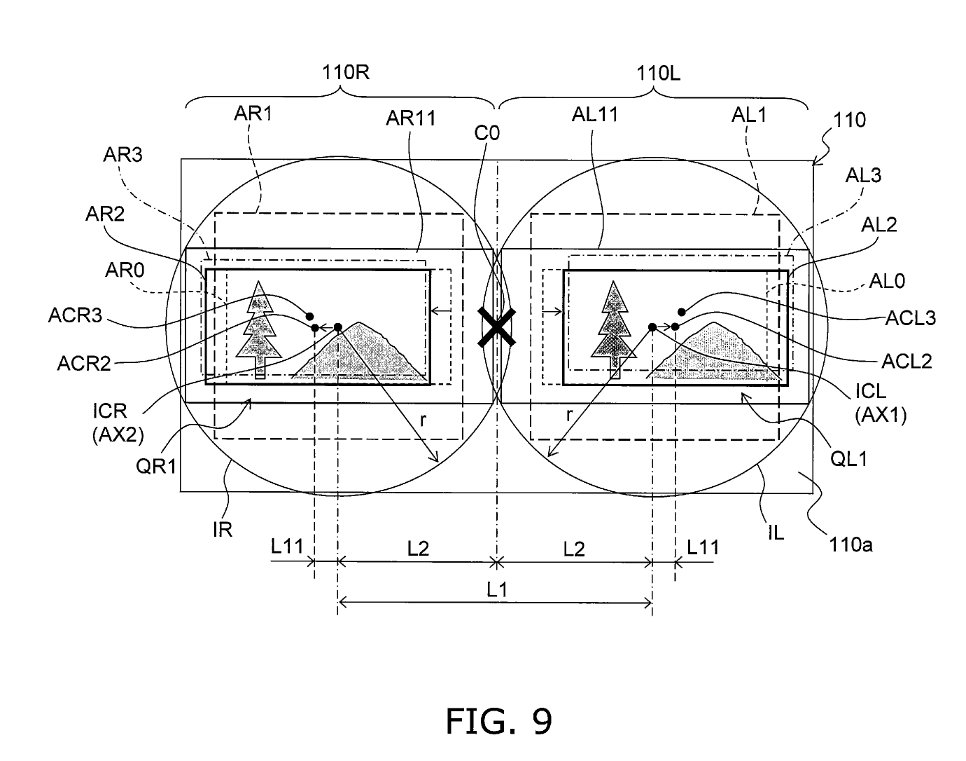

Distance L2 (design value) from the center C0 (see FIG. 9) of the imaging element (the CMOS image sensor 110) to the optical axis center (the center ICR of the image circle IR or the center ICL or the image circle IL shown in FIG. 9)

(C) Angle of Convergence

Angle θ1 formed by the first optical axis (AX1) and the second optical axis (AX2) (see FIG. 10)

(D) Amount of Left-Eye Deviation

Deviation amount DL (horizontal: DLx, vertical: DLy) of the left-eye optical image (QL1) with respect to the optical axis position (design value) of the left-eye optical system (OL) on the imaging element (the CMOS image sensor 110)

(E) Amount of Right-Eye Deviation

Deviation amount DR (horizontal: DRx, vertical: DRy) of the right-eye optical image (QR1) with respect to the optical axis position (design value) of the right-eye optical system (OR) on the imaging element (the CMOS image sensor 110)

(F) Effective Imaging Area

Radius r of the image circles (AL1, AR1) of the left-eye optical system (OL) and the right-eye optical system (OR) (see FIG. 8)

(G) Recommended Convergence Point Distance

Distance L10 from the subject (convergence point P0) to the light receiving face 110a of the CMOS image sensor 110, recommended in using the interchangeable lens unit 200 to perform three-dimensional imaging (see FIG. 10)

(H) Extraction Position Correction Amount

Distance L11 from points (P11 and P12) at which the first optical axis AX1 and the second optical axis AX2 reach the light receiving face 110a when the convergence angle θ1 is zero, to points (P21 and P22) at which the first optical axis AX1 and the second optical axis AX2 reach the light receiving face 110a when the size of the convergence angle θ1 corresponds to the recommended convergence point distance L10 (see FIG. 10) (also called the “distance on the imaging element from the reference extraction position corresponding to when the convergence point distance is infinity, to a recommended extraction position corresponding to the recommended convergence point distance of the interchangeable lens unit”)

(I) Limiting Convergence Point Distance

Shortest distance L12 from the subject to the light receiving face 110a when the extraction regions of the left-eye optical image QL1 and the right-eye optical image QL2 both fit within the effective imaging area in using the interchangeable lens unit 200 to perform three-dimensional imaging (see FIG. 10)

(J) Extraction Position Limiting Correction Amount

Distance L13 from points (P11 and P12) at which the first optical axis AX1 and the second optical axis AX2 reach the light receiving face 110a when the convergence angle θ1 is zero, to points (P31 and P32) at which the first optical axis AX1 and the second optical axis AX2 reach the light receiving face 110a when the size of the convergence angle θ1 corresponds to the limiting convergence point distance L12 (see FIG. 10)

Of the above parameters, the optical axis position, the left-eye deviation, and the right-eye deviation are parameters characteristic of a side-by-side imaging type of three-dimensional optical system.

The above parameters will now be described through reference to FIGS. 9 and 10. FIG. 9 is a diagram of the CMOS image sensor 110 as viewed from the subject side. The CMOS image sensor 110 has a light receiving face 110a (see FIGS. 9 and 10) that receives light that has passed through the interchangeable lens unit 200. An optical image of the subject is formed on the light receiving face 110a. As shown in FIG. 9, the light receiving face 110a has a first region 110L and a second region 110R disposed adjacent to the first region 110L. The surface area of the first region 110L is the same as the surface area of the second region 110R. As shown in FIG. 9, when viewed from the rear face side of the camera body 100 (in a see-through view), the first region 110L accounts for the left half of the light receiving face 110a, and the second region 110R accounts for the right half of the light receiving face 110a. As shown in FIG. 9, when imaging is performed using the interchangeable lens unit 200, a left-eye optical image QL1 is formed in the first region 110L, and a right-eye optical image QR1 is formed in the second region 110R.

As shown in FIG. 9, the image circle IL of the left-eye optical system OL and the image circle IR of the right-eye optical system OR are defined for design purposes on the CMOS image sensor 110. The center ICL of the image circle IL (an example of a reference extraction position) coincides with the designed position of the first optical axis AX10 of the left-eye optical system OL, and the center ICR of the image circle IR (an example of a reference extraction position) coincides with the designed position of the second optical axis AX20 of the right-eye optical system OR. Here, the “designed position” corresponds to when the first optical axis AX10 and the second optical axis AX20 have their convergence point at infinity. Therefore, the designed base line length is the designed distance L1 between the first optical axis AX10 and the second optical axis AX20 on the CMOS image sensor 110. Also, the optical axis position is the designed distance L2 between the center C0 of the light receiving face 110a and the first optical axis AX10 (or the designed distance L2 between the center C0 and the second optical axis AX20).

As shown in FIG. 9, an extractable range AL1 and a landscape imaging-use extractable range AL11 are set based on the center ICL, and an extractable range AR1 and a landscape imaging-use extractable range AR1 are set based on the center ICR. Since the center ICL is set substantially at the center position of the first region 110L of the light receiving face 110a, wider extractable ranges AL1 and AL11 can be ensured within the image circle IL. Also, since the center ICR is set substantially at the center position of the second region 110R, wider extractable ranges AR1 and AR11 can be ensured within the image circle IR.

The extractable ranges AL0 and AR0 shown in FIG. 9 are regions serving as a reference in extracting left-eye image data and right-eye image data. The designed extractable range AL0 for left-eye image data is set using the center ICL of the image circle IL (or the first optical axis AX10) as a reference, and is positioned at the center of the extractable range AL1. Also, the designed extractable range AR0 for right-eye image data is set using the center ICR of the image circle IR (or the second optical axis AX20) as a reference, and is positioned at the center of the extractable range AR1.

Since the optical axis centers ICL and ICR have their convergence points at infinity, if the left-eye image data and right-eye image data are extracted using the extraction regions AL0 and AR0 as a reference, the position where the subject is reproduced in stereoscopic view is an infinity position. Therefore, when an interchangeable lens unit 200 that is intended for close-up imaging (such as when the distance from the imaging position to the main subject is about 1 meter) is used at such a setting, there is a problem in that the subject pops out from the screen too much in the three-dimensional image in stereoscopic view.

In view of this, with this camera body 100, the extraction region AR0 is offset to the recommended extraction region AR3, and the extraction region AL0 to the recommended extraction region AR3, each by the distance L11, so that a subject that is away from the digital camera 1 by the recommended convergence point distance L10 during imaging will be reproduced on the screen in stereoscopic view. The correction processing performed for extraction regions using the extraction position correction amount L11 will be discussed below.

2: Configuration of Camera Body

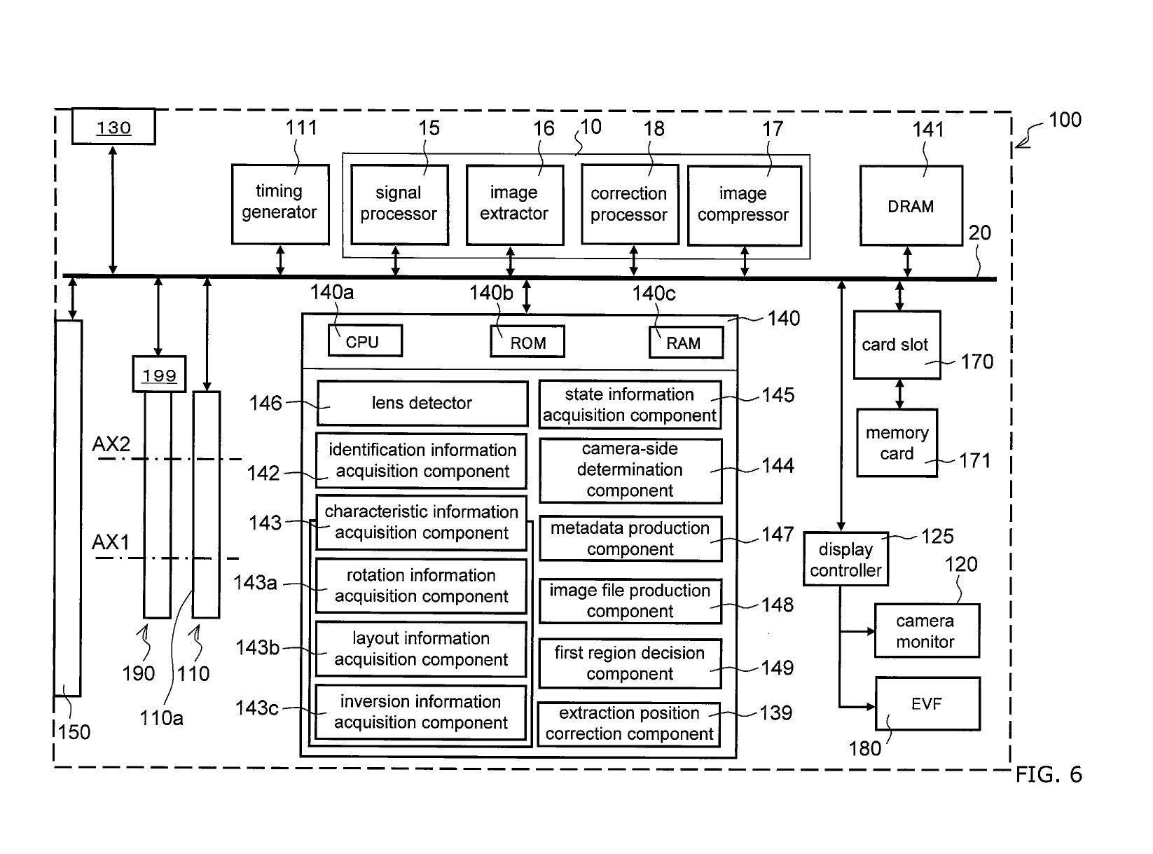

As shown in FIGS. 4 and 6, the camera body 100 comprises the CMOS image sensor 110, a camera monitor 120, an electronic viewfinder 180, a display controller 125, a manipulation component 130, a card slot 170, a shutter unit 190, the body mount 150, a DRAM 141, an image processor 10, and the camera controller 140 (an example of a controller). These components are connected to a bus 20, allowing data to be exchanged between them via the bus 20.

(1) CMOS Image Sensor 110

The CMOS image sensor 110 converts an optical image of a subject (hereinafter also referred to as a subject image) formed by the interchangeable lens unit 200 into an image signal. As shown in FIG. 6, the CMOS image sensor 110 outputs an image signal based on a timing signal produced by a timing generator 112. The image signal produced by the CMOS image sensor 110 is digitized and converted into image data by a signal processor 15 (discussed below). The CMOS image sensor 110 can acquire still picture data and moving picture data. The acquired moving picture data is also used for the display of a through-image.

The “through-image” referred to here is an image, out of the moving picture data, that is not recorded to a memory card 171. The through-image is mainly a moving picture, and is displayed on the camera monitor 120 or the electronic viewfinder (hereinafter also referred to as EVF) 180 in order to determine the composition of a moving picture or still picture.

As discussed above, the CMOS image sensor 110 has the light receiving face 110a (see FIGS. 6 and 9) that receives light that has passed through the interchangeable lens unit 200. An optical image of the subject is formed on the light receiving face 110a. As shown in FIG. 9, when viewed from the rear face side of the camera body 100, the first region 110L accounts for the left half of the light receiving face 110a, while the second region 110R accounts for the right half. When imaging is performed with the interchangeable lens unit 200, a left-eye optical image is formed in the first region 110L, and a right-eye optical image is formed in the second region 110R.

The CMOS image sensor 110 is an example of an imaging element that converts an optical image of a subject into an electrical image signal. “Imaging element” is a concept that encompasses the CMOS image sensor 110 as well as a CCD image sensor or other such opto-electric conversion element.

(2) Camera Monitor 120

The camera monitor 120 is a liquid crystal display, for example, and displays display-use image data as an image. This display-use image data is image data that has undergone image processing, data for displaying the imaging conditions, operating menu, and so forth of the digital camera 1, or the like, and is produced by the camera controller 140. The camera monitor 120 is capable of selectively displaying both moving and still pictures. As shown in FIG. 5, in this embodiment the camera monitor 120 is disposed on the rear face of the camera body 100, but the camera monitor 120 may be disposed anywhere on the camera body 100.

The camera monitor 120 is an example of a display component provided to the camera body 100. The display component could also be an organic electroluminescence component, an inorganic electroluminescence component, a plasma display panel, or another such device that allows images to be displayed.

(3) Electronic Viewfinder 180

The electronic viewfinder 180 displays as an image the display-use image data produced by the camera controller 140. The EVF 180 is capable of selectively displaying both moving and still pictures. The EVF 180 and the camera monitor 120 may both display the same content, or may display different content, and they are both controlled by the display controller 125.

(4) Manipulation Component 130

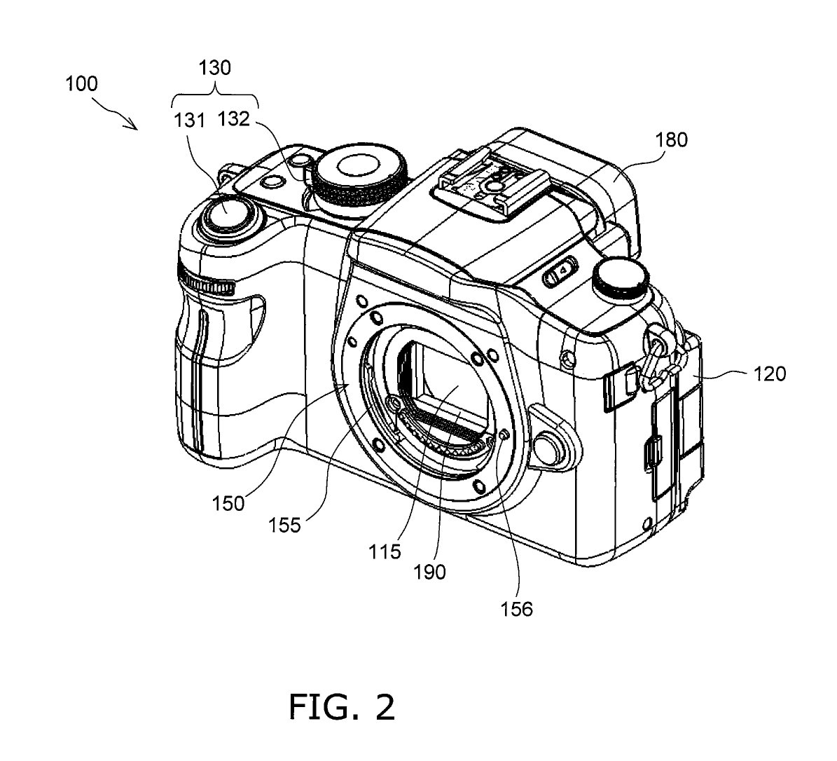

As shown in FIGS. 1 and 2, the manipulation component 130 has a release button 131 and a power switch 132. The release button 131 is used for shutter operation by the user. The power switch 132 is a rotary lever switch provided to the top face of the camera body 100. The manipulation component 130 encompasses a button, lever, dial, touch panel, or the like, so long as it can be operated by the user.

(5) Card Slot 170

The card slot 170 allows the memory card 171 to be inserted. The card slot 170 controls the memory card 171 based on control from the camera controller 140. More specifically, the card slot 170 stores image data on the memory card 171 and outputs image data from the memory card 171. For example, the card slot 170 stores moving picture data on the memory card 171 and outputs moving picture data from the memory card 171.

The memory card 171 is able to store the image data produced by the camera controller 140 in image processing. For instance, the memory card 171 can store uncompressed raw image files, compressed JPEG image files, or the like. Furthermore, the memory card 171 can store stereo image files in multi-picture format (MPF).

Also, image data that have been internally stored ahead of time can be outputted from the memory card 171 via the card slot 170. The image data or image files outputted from the memory card 171 are subjected to image processing by the camera controller 140. For example, the camera controller 140 produces display-use image data by subjecting the image data or image files acquired from the memory card 171 to expansion or the like.

The memory card 171 is further able to store moving picture data produced by the camera controller 140 in image processing. For instance, the memory card 171 can store moving picture files compressed according to H.264/AVC, which is a moving picture compression standard. Stereo moving picture files can also be stored. The memory card 171 can also output, via the card slot 170, moving picture data or moving picture files stored internally ahead of time. The moving picture data or moving picture files outputted from the memory card 171 are subjected to image processing by the camera controller 140. For example, the camera controller 140 subjects the moving picture data or moving picture files acquired from the memory card 171 to expansion processing and produces display-use moving picture data.

(6) Shutter Unit 190

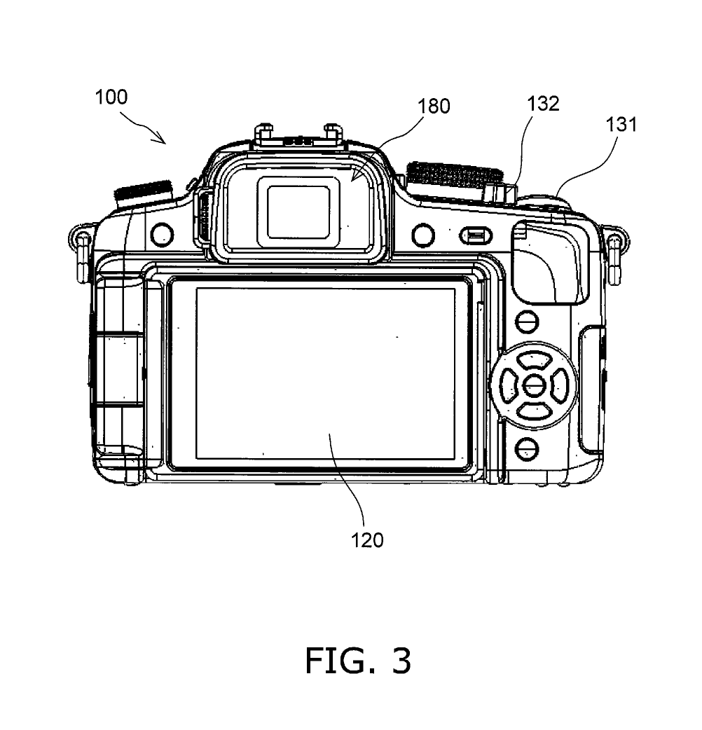

The shutter unit 190 is what is known as a focal plane shutter, and is disposed between the body mount 150 and the CMOS image sensor 110, as shown in FIG. 3. The charging of the shutter unit 190 is performed by a shutter motor 199. The shutter motor 199 is a stepping motor, for example, and is controlled by the camera controller 140.

(7) Body Mount 150

The body mount 150 allows the interchangeable lens unit 200 to be mounted, and holds the interchangeable lens unit 200 in a state in which the interchangeable lens unit 200 is mounted. The body mount 150 can be mechanically and electrically connected to the lens mount 250 of the interchangeable lens unit 200. Data and/or control signals can be sent and received between the camera body 100 and the interchangeable lens unit 200 via the body mount 150 and the lens mount 250. More specifically, the body mount 150 and the lens mount 250 send and receive data and/or control signals between the camera controller 140 and the lens controller 240.

(8) Camera Controller 140

The camera controller 140 controls the entire camera body 100. The camera controller 140 is electrically connected to the manipulation component 130. Manipulation signals from the manipulation component 130 are inputted to the camera controller 140. The camera controller 140 uses the DRAM 141 as a working memory during control operation or during the image processing operation discussed below.

Also, the camera controller 140 sends signals for controlling the interchangeable lens unit 200 through the body mount 150 and the lens mount 250 to the lens controller 240, and indirectly controls the various components of the interchangeable lens unit 200. The camera controller 140 also receives various kinds of signal from the lens controller 240 via the body mount 150 and the lens mount 250.

The camera controller 140 has a CPU (central processing unit) 140a, a ROM (read only memory) 140b, and a RAM (random access memory) 140c, and can perform various functions by reading the programs stored in the ROM 140b into the CPU 140a.

Details of Camera Controller 140

The functions of the camera controller 140 will now be described in detail.

First, the camera controller 140 detects whether or not the interchangeable lens unit 200 is mounted to the camera body 100 (more precisely, to the body mount 150). More specifically, as shown in FIG. 6, the camera controller 140 has a lens detector 146. When the interchangeable lens unit 200 is mounted to the camera body 100, signals are exchanged between the camera controller 140 and the lens controller 240. The lens detector 146 determines whether or not the interchangeable lens unit 200 has been mounted based on this exchange of signals.

Also, the camera controller 140 has various other functions, such as the function of determining whether or not the interchangeable lens unit mounted to the body mount 150 is compatible with three-dimensional imaging, and the function of acquiring information related to three-dimensional imaging from the interchangeable lens unit. The camera controller 140 has an identification information acquisition component 142, a characteristic information acquisition component 143, a camera-side determination component 144, a state information acquisition component 145, an extraction position correction component 139, a region decision component 149, a metadata production component 147, and an image file production component 148.

The identification information acquisition component 142 acquires the lens identification information F1, which indicates whether or not the interchangeable lens unit 200 is compatible with three-dimensional imaging, from the interchangeable lens unit 200 mounted to the body mount 150. As shown in FIG. 7A, the lens identification information F1 is information indicating whether or not the interchangeable lens unit mounted to the body mount 150 is compatible with three-dimensional imaging, and is stored in the flash memory 242 of the lens controller 240, for example. The lens identification information F1 is a three-dimensional imaging determination flag stored at a specific address in the flash memory 242. The identification information acquisition component 142 temporarily stores the acquired lens identification information F1 in the DRAM 141, for example.

The camera-side determination component 144 determines whether or not the interchangeable lens unit 200 mounted to the body mount 150 is compatible with three-dimensional imaging based on the lens identification information F1 acquired by the identification information acquisition component 142. If it is determined by the camera-side determination component 144 that the interchangeable lens unit 200 mounted to the body mount 150 is compatible with three-dimensional imaging, the camera controller 140 permits the execution of a three-dimensional imaging mode. On the other hand, if it is determined by the camera-side determination component 144 that the interchangeable lens unit 200 mounted to the body mount 150 is not compatible with three-dimensional imaging, the camera controller 140 does not execute the three-dimensional imaging mode. In this case the camera controller 140 permits the execution of a two-dimensional imaging mode.

The characteristic information acquisition component 143 (an example of a correction information acquisition component) acquires from the interchangeable lens unit 200 the lens characteristic information F2, which indicates the characteristics of the optical system installed in the interchangeable lens unit 200. More specifically, the characteristic information acquisition component 143 acquires the above-mentioned lens characteristic information F2 from the interchangeable lens unit 200 when it has been determined by the camera-side determination component 144 that the interchangeable lens unit 200 is compatible with three-dimensional imaging. The characteristic information acquisition component 143 temporarily stores the acquired lens characteristic information F2 in the DRAM 141, for example.

The state information acquisition component 145 acquires the lens state information F3 (imaging possibility flag) produced by the state information production component 243. This lens state information F3 is used in determining whether or not the interchangeable lens unit 200 is in a state that allows imaging. The state information acquisition component 145 temporarily stores the acquired lens state information F3 in the DRAM 141, for example.

The extraction position correction component 139 corrects the used extraction regions which are used in extracting image data (more precisely, the center position of the used extraction regions), based on the extraction position correction amount L11. In the initial state, the used extraction regions are set to the extraction regions AL0 and AR0, the center of the extraction region AL0 is set to the center ICL of the image circle IL, and the center of the extraction region AR0 is set to the center ICR of the image circle IR. The extraction position correction component 139 moves the extraction centers horizontally by the extraction position correction amount L11 from the centers ICL and ICR, and sets new extraction centers ACL2 and ACR2 (an example of recommended extraction positions) as a reference for extracting left-eye image data and right-eye image data. The used extraction regions for which the extraction centers ACL2 and ACR2 are used as a reference become the extraction regions AL2 and AR2 shown in FIG. 9. Thus using the extraction position correction amount L11 to correct the position of the extraction centers allows the used extraction regions to be set according to the characteristics of the interchangeable lens unit, and allows a better stereo image to be obtained.

In this embodiment, since the interchangeable lens unit 200 has a zoom function, if the focal distance changes due to zooming, the recommended convergence point distance L10 changes, and this is also accompanied by a change in the extraction position correction amount L11. Therefore, the extraction position correction amount L11 may be recalculated by computation according to the zoom position.

More specifically, the lens controller 240 can ascertain the zoom position based on the detection result of a zoom position sensor (not shown). The lens controller 240 sends zoom position information to the camera controller 140 at a specific period. The zoom position information is temporarily stored in the DRAM 141.

Meanwhile, the extraction position correction component 139 calculates the extraction position correction amount suited to the focal distance based on the zoom position information, the recommended convergence point distance L10, and the extraction position correction amount L11, for example. Here, information indicating the relation between the zoom position information, the recommended convergence point distance L10, and the extraction position correction amount L11 (such as a computation formula or a data table) may be stored, for example, in the camera body 100, and in the flash memory 242 of the interchangeable lens unit 200. The extraction position correction amount is updated at a specific period. The updated extraction position correction amount is stored at a specific address of the DRAM 141. In this case, the extraction position correction component 139 corrects the center positions of the extraction regions AL0 and AR0 based on the newly calculated extraction position correction amount, just as with the extraction position correction amount L11.

The region decision component 149 decides the size and position of the extraction regions AL3 and AR3 used in extracting the left-eye image data and the right-eye image data with an image extractor 16. More specifically, the region decision component 149 decides the size and position of the extraction regions AL3 and AR3 of the left-eye image data and the right-eye image data based on the extraction centers ACL2 and ACR2 calculated by the extraction position correction component 139, the radius r of the image circles IL and IR, and the left-eye deviation amount DL and right-eye deviation amount DR included in the lens characteristic information F2.

Furthermore, the region decision component 149 may decide the starting point for extraction processing of the image data so that the left-eye image data and the right-eye image data can be properly extracted, based on a 180 degree rotation flag indicating whether or not the left-eye optical image and right-eye optical image have rotated, a layout change flag indicating the left-right layout of the left-eye optical image and the right-eye optical image, and a mirror inversion flag indicating whether or not the left-eye optical image and the right-eye optical image have undergone minor inversion.

The metadata production component 147 produces metadata with set base line length and angle of convergence. The base line length and angle of convergence are used in displaying a stereo image.

The image file production component 148 produces MPF stereo image files by combining left- and right-eye image data compressed by an image compressor 17 (discussed below). The image files thus produced are sent to the card slot 170 and stored on the memory card 171, for example.

(9) Image Processor 10

The image processor 10 has the signal processor 15, the image extractor 16, a correction processor 18, and the image compressor 17.

The signal processor 15 digitizes the image signal produced by the CMOS image sensor 110, and produces basic image data for the optical image formed on the CMOS image sensor 110. More specifically, the signal processor 15 converts the image signal outputted from the CMOS image sensor 110 into a digital signal, and subjects this digital signal to digital signal processing such as noise elimination or contour enhancement. The image data produced by the signal processor 15 is temporarily stored as raw data in the DRAM 141. The image data produced by the signal processor 15 is called basic image data.

The image extractor 16 extracts left-eye image data and right-eye image data from the basic image data produced by the signal processor 15. The left-eye image data corresponds to part of the left-eye optical image QL1 formed by the left-eye optical system OL. The right-eye image data corresponds to part of the right-eye optical image QR1 formed by the right-eye optical system OR. The image extractor 16 extracts left-eye image data and right-eye image data from the basic image data held in the DRAM 141, based on the extraction regions AL3 and AR3 decided by the region decision component 149. The left-eye image data and right-eye image data extracted by the image extractor 16 are temporarily stored in the DRAM 141.

The correction processor 18 performs distortion correction, shading correction, and other such correction processing on the extracted left-eye image data and right-eye image data. After this correction processing, the left-eye image data and right-eye image data are temporarily stored in the DRAM 141.

The image compressor 17 performs compression processing on the corrected left- and right-eye image data stored in the DRAM 141, based on a command from the camera controller 140. This compression processing reduces the image data to a smaller size than that of the original data. An example of the method for compressing the image data is the JPEG (Joint Photographic Experts Group) method in which compression is performed on the image data for each frame. The compressed left-eye image data and right-eye image data are temporarily stored in the DRAM 141.

Operation of Digital Camera

### (1) When Power is on

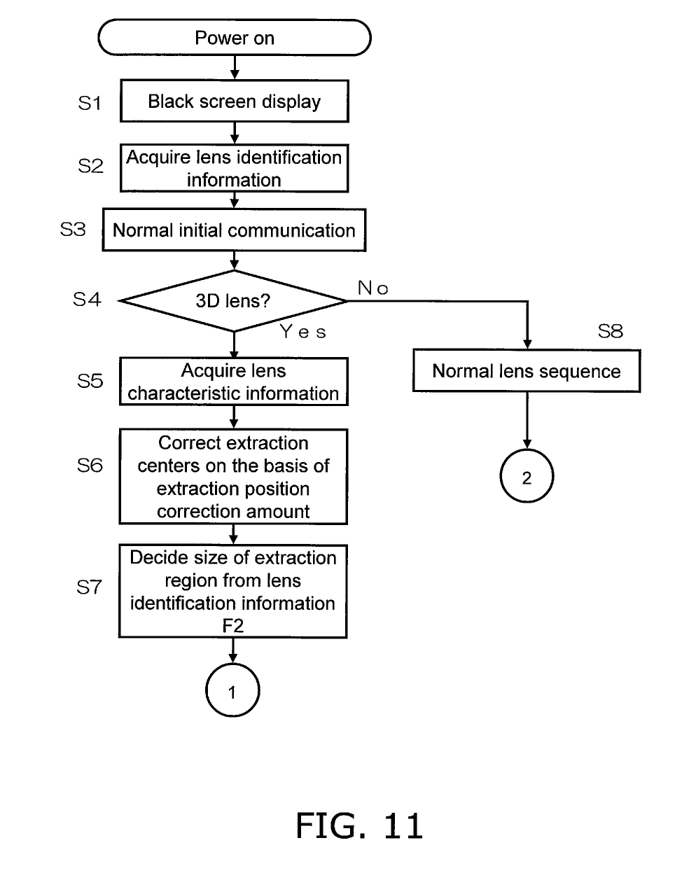

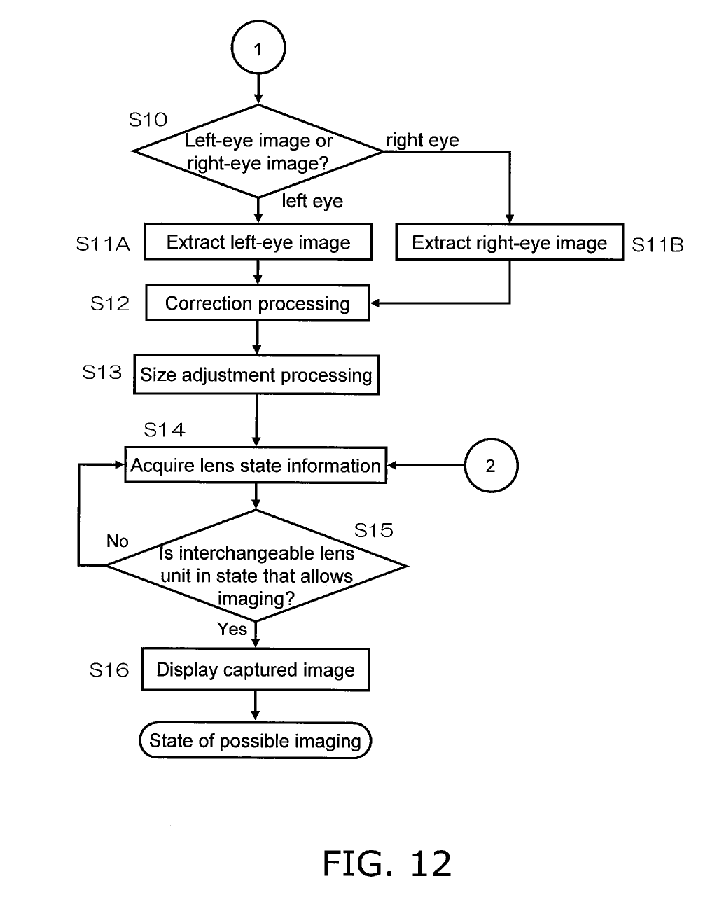

Determination of whether or not the interchangeable lens unit 200 is compatible with three-dimensional imaging is possible either when the interchangeable lens unit 200 is mounted to the camera body 100 in a state in which the power to the camera body 100 is on, or when the power is turned on to the camera body 100 in a state in which the interchangeable lens unit 200 has been mounted to the camera body 100. Here, the latter case will be used as an example to describe the operation of the digital camera 1 through reference to FIGS. 8A, 8B, 11, and 12. Of course, the same operation may also be performed in the former case.

When the power is turned on, a black screen is displayed on the camera monitor 120 under control of the display controller 125, and the blackout state of the camera monitor 120 is maintained (step S1). Next, the identification information acquisition component 142 of the camera controller 140 acquires the lens identification information F1 from the interchangeable lens unit 200 (step S2). More specifically, as shown in FIGS. 8A and 8B, when the mounting of the interchangeable lens unit 200 is detected by the lens detector 146 of the camera controller 140, the camera controller 140 sends a model confirmation command to the lens controller 240. This model confirmation command is a command that requests the lens controller 240 to send the status of a three-dimensional imaging determination flag for the lens identification information F1. As shown in FIG. 8B, since the interchangeable lens unit 200 is compatible with three-dimensional imaging, upon receiving the model confirmation command, the lens controller 240 sends the lens identification information F1 (three-dimensional imaging determination flag) to the camera body 100. The identification information acquisition component 142 temporarily stores the status of this three-dimensional imaging determination flag in the DRAM 141.

Next, ordinary initial communication is executed between the camera body 100 and the interchangeable lens unit 200 (step S3). This ordinary initial communication is also performed between the camera body and an interchangeable lens unit that is not compatible with three-dimensional imaging, and information related to the specifications of the interchangeable lens unit 200 (its focal distance, F stop value, etc.) is sent from the interchangeable lens unit 200 to the camera body 100, for example.

After this ordinary initial communication, the camera-side determination component 144 determines whether or not the interchangeable lens unit 200 mounted to the body mount 150 is compatible with three-dimensional imaging (step S4). More specifically, the camera-side determination component 144 determines whether or not the mounted interchangeable lens unit 200 is compatible with three-dimensional imaging based on the lens identification information F1 (three-dimensional imaging determination flag) acquired by the identification information acquisition component 142.

If the mounted interchangeable lens unit is not compatible with three-dimensional imaging, the normal sequence corresponding to two-dimensional imaging is executed, and the processing moves to step S14 (step S8). If an interchangeable lens unit that is compatible with three-dimensional imaging, such as the interchangeable lens unit 200, is mounted, then the lens characteristic information F2 is acquired by the characteristic information acquisition component 143 from the interchangeable lens unit 200 (step S5). More specifically, as shown in FIG. 8B, a characteristic information transmission command is sent from the characteristic information acquisition component 143 to the lens controller 240. This characteristic information transmission command is a command that requests the transmission of the lens characteristic information F2. When it receives this command, the camera controller 140 sends the lens characteristic information F2 to the camera controller 140. The characteristic information acquisition component 143 stores the lens characteristic information F2 in the DRAM 141, for example.

After acquisition of the lens characteristic information F2, the positions of the extraction centers of the extraction regions AL0 and AR0 are corrected by the extraction position correction component 139 (step S6). More specifically, the extraction position correction component 139 corrects the center positions of the extraction regions AL0 and AR0 based on the extraction position correction amount L11 (or an extraction position correction amount newly calculated from the extraction position correction amount L11). The extraction position correction component 139 sets the extraction centers ACL2 and ACR2 as new references for extracting left-eye image data and right-eye image data by moving the extraction centers horizontally by the extraction position correction amount L11 (or an extraction position correction amount newly calculated from the extraction position correction amount L11) from the centers ICL and ICR.

Further, the size and positions of the extraction regions AL3 and AR3 are decided by the region decision component 149 based on the lens identification information F2 (step S7). For example, as discussed above, the size of the extraction regions AL3 and AR3 is decided by the region decision component 149 based on the optical axis position, the effective imaging area (radius r), the extraction centers ACL2 and ACR2, the left-eye deviation amount DL, the right-eye deviation amount DR, and the size of the CMOS image sensor 110. For example, the region decision component 149 decides the size of the extraction regions AL3 and AR3 based on the above information so that the extraction regions AL3 and AR3 will fit within the landscape imaging-use extractable ranges AL11 and AR11.

The limiting convergence point distance L12 and the extraction position limiting correction amount L13 may also be used in deciding the size of the extraction regions AL3 and AR3 by the region decision component 149.

The region decision component 149 may also decide the extraction method, namely whether to extract the image from the extraction region AL3 or AR3 as the right-eye image, whether to rotate the image, or whether to subject the image to minor inversion.

Further, the image used for live-view display is selected from among the left- and right-eye image data (step S10). For example, the user may select from among the left- and right-eye image data, or the one pre-decided by the camera controller 140 may be set for display use. The selected image data is set as the display-use image, and extracted by the image extractor 16 (step S11A or 11B).

Then, the extracted image data is subjected by the correction processor 18 to distortion correction, shading correction, or other such correction processing (step S12). Further, size adjustment processing is performed on the corrected image data by the display controller 125, and display-use image data is produced (step S13). This correction-use image data is temporarily stored in the DRAM 141.

After this, the state information acquisition component 145 confirms whether or not the interchangeable lens unit is in a state that allows imaging (step S14). More specifically, with the interchangeable lens unit 200, when the lens-side determination component 244 receives the above-mentioned characteristic information transmission command, the lens-side determination component 244 determines that the camera body 100 is compatible with three-dimensional imaging (see FIG. 8B). Meanwhile, the lens-side determination component 244 determines that the camera body is not compatible with three-dimensional imaging if no characteristic information transmission command has been sent from the camera body within a specific period of time (see FIG. 8A).

The state information production component 243 sets the status of an imaging possibility flag (an example of standby information) indicating whether or not the three-dimensional optical system G is in the proper imaging state, based on the determination result of the lens-side determination component 244. The state information production component 243 sets the status of the imaging possibility flag to “possible” after the completion of the initialization of the various components when the lens-side determination component 244 has determined that the camera body is compatible with three-dimensional imaging (FIG. 8B). On the other hand, the state information production component 243 sets the status of the imaging possibility flag to “impossible,” regardless of whether or not the initialization of the various components has been completed, when the lens-side determination component 244 has determined that the camera body is not compatible with three-dimensional imaging (see FIG. 8A). In step S14, if a command is sent requesting the transmission of status information about the imaging possibility flag from the state information acquisition component 145 to the lens controller 240, the state information production component 243 sends status information about the imaging possibility flag to the camera controller 140. The status information about the imaging possibility flag is sent to the camera controller 140. With the camera body 100, the state information acquisition component 145 temporarily stores the status information about the imaging possibility flag sent from the lens controller 240 at a specific address in the DRAM 141.

Further, the state information acquisition component 145 determines whether or not the interchangeable lens unit 200 is in a state that allows imaging, based on the stored imaging possibility flag (step S15). If the interchangeable lens unit 200 is not in a state that allows imaging, the processing of steps S14 and S15 is repeated at a specific period. On the other hand, if the interchangeable lens unit 200 is in a state that allows imaging, the display-use image data produced in step S13 is displayed as a visible image on the camera monitor 120 (step S16). From step S16 onward, a left-eye image, a right-eye image, an image that is a combination of a left-eye image and a right-eye image, or a three-dimensional display using a left-eye image and a right-eye image is displayed in live view.

### (2) Three-Dimensional Still Picture Imaging

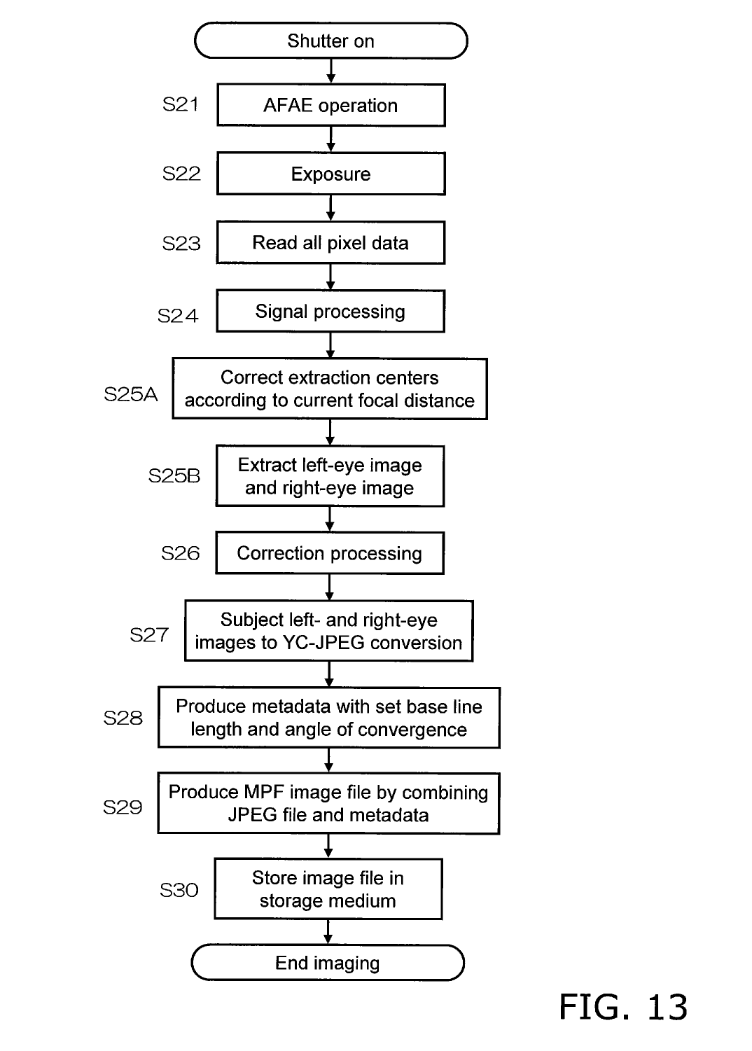

The operation in three-dimensional still picture imaging will now be described through reference to FIG. 13.

When the user presses the release button 131, autofocusing (AF) and automatic exposure (AE) are executed, and then exposure is commenced (steps S21 and S22). An image signal from the CMOS image sensor 110 (full pixel data) is taken in by the signal processor 15, and the image signal is subjected to AD conversion or other such signal processing by the signal processor 15 (steps S23 and S24). The basic image data produced by the signal processor 15 is temporarily stored in the DRAM 141.

After signal processing, the positions of the extraction regions AL3 and AR3 are corrected by the extraction position correction component 139 according to the focal distance (step S25A). More specifically, the extraction position correction component 139 calculates the extraction position correction amounts suited to the current focal distance based on zoom position information, the recommended convergence point distance L10, and the extraction position correction amount L11, for example. In this case, the center positions of the extraction regions AL0 and AR0 are corrected by the extraction position correction component 139 based on the newly calculated extraction position correction amounts, just as with the extraction position correction amount L11.

Next, the image extractor 16 extracts left-eye image data and right-eye image data from the basic image data (step S25B). The values decided in step S7 are used for the size of the extraction regions AL3 and AR3 here.

The correction processor 18 then subjects the extracted left-eye image data and right-eye image data to correction processing, and the image compressor 17 performs JPEG compression or other such compression processing on the left-eye image data and right-eye image data (steps S26 and S27).

After compression, the metadata production component 147 of the camera controller 140 produces metadata setting the base line length and the angle of convergence (step S28).

After metadata production, the compressed left-eye and right-eye image data are combined with the metadata, and MPF image files are produced by the image file production component 148 (step S29). The produced image files are sent to the card slot 170 and stored on the memory card 171, for example. If these image files are displayed in 3D using the base line length and the angle of convergence, the displayed image can be seen in stereoscopic view using special glasses or the like.

Characteristics of Camera Body

The characteristics of the camera body described above are compiled below.

(1) With the camera body 100, lens identification information is acquired by the identification information acquisition component 142 from the interchangeable lens unit mounted to the body mount 150. For example, the lens identification information F1, which indicates whether or not the interchangeable lens unit 200 is compatible with three-dimensional imaging, is acquired by the identification information acquisition component 142 from the interchangeable lens unit 200 mounted to the body mount 150. Accordingly, when an interchangeable lens unit 200 that is compatible with three-dimensional imaging is mounted to the camera body 100, the camera-side determination component 144 deems the interchangeable lens unit 200 to be compatible with three-dimensional imaging based on the lens identification information F1. Conversely, when an interchangeable lens unit that is not compatible with three-dimensional imaging is mounted, the camera-side determination component 144 deems the interchangeable lens unit to be incompatible with three-dimensional imaging based on the lens identification information F1.

Thus, this camera body 100 is compatible with various kinds of interchangeable lens unit, such as interchangeable lens units that are and are not compatible with three-dimensional imaging.

(2) Also, with the camera body 100, the lens characteristic information F2, which indicates the characteristics of an interchangeable lens unit (such as the characteristics of the optical system), is acquired by the characteristic information acquisition component 143. For example, lens characteristic information F2 indicating the characteristics of the three-dimensional optical system G installed in the interchangeable lens unit 200 is acquired by the characteristic information acquisition component 143 from the interchangeable lens unit 200. Therefore, image processing and other such operations in the camera body 100 can be adjusted according to the characteristics of the three-dimensional optical system installed in the interchangeable lens unit.

Also, if it is determined by the camera-side determination component 144 that the interchangeable lens unit mounted to the body mount 150 is compatible with three-dimensional imaging, the lens characteristic information F2 is acquired by the characteristic information acquisition component 143 from the interchangeable lens unit. Therefore, if the interchangeable lens unit is not compatible with three-dimensional imaging, the unnecessary exchange of data can be eliminated, which should speed up the processing performed by the camera body 100.

(3) With this camera body 100, the center positions of the extraction regions AL0 and AR0 are corrected to positions corresponding to the recommended convergence point distance L10 based on the extraction position correction amount L11, so the extraction regions can be set so that they are suited to the characteristics of the interchangeable lens unit that is mounted. Therefore, a better stereo image can be acquired with this camera body 100.

(4) Further, with this camera body 100, the size and position of the extraction regions AL3 and AR3 of the left-eye image data and right-eye image data are decided by the region decision component 149 based on the lens identification information F2. Therefore, even if the extraction centers are corrected by the extraction position correction component 139, the characteristics of the interchangeable lens unit can prevent the extraction regions AL3 and AR3 of the left-eye image data and right-eye image data from exceeding the effective imaging area of the CMOS image sensor 110.

(5) As discussed above, this camera body 100 is compatible with various kinds of interchangeable lens unit, such as interchangeable lens units that are and are not compatible with three-dimensional imaging.

Features of Interchangeable Lens Unit

The interchangeable lens unit 200 also has the following features.

(1) With this interchangeable lens unit 200, since the extraction position correction amount L11 is stored in the flash memory 242, the positions of the extraction centers can be corrected to positions corresponding to the recommended convergence point distance L10. Therefore, a better stereo image is easier to obtain.

### Other Embodiments

The present invention is not limited to or by the above embodiments, and various changes and modifications are possible without departing from the gist of the invention.

(A) An imaging device and a camera body were described using as an example the digital camera 1 having no minor box, but compatibility with three-dimensional imaging is also possible with a digital single lens reflex camera having a mirror box. The imaging device may be one that is capable of capturing not only of still pictures, but also moving pictures.

(B) An interchangeable lens unit was described using the interchangeable lens unit 200 as an example, but the constitution of the three-dimensional optical system is not limited to that in the above embodiments. As long as imaging can be handled with a single imaging element, the three-dimensional optical system may have some other constitution.

(C) The three-dimensional optical system G is not limited to a side-by-side imaging system, and a time-division imaging system may instead be employed as the optical system for the interchangeable lens unit, for example. Also, in the above embodiments, an ordinary side-by-side imaging system was used as an example, but a horizontal compression side-by-side imaging system in which left- and left-eye images are compressed horizontally, or a rotated side-by-side imaging system in which left- and right-eye images are rotated 90 degrees may be employed.

(D) In FIG. 9, the image size is changed, but imaging may be prohibited if the imaging element is too small. For instance, the region decision component 149 decides the size of the extraction regions AL3 and AR3, but if the size of the extraction regions AL3 and AR3 here is below a specific size, a warning to that effect may be displayed on the display monitor 120. Also, even if the size of the extraction regions AL3 and AR3 is below a specific size, as long as the size of the extraction regions can be made relatively large by changing the aspect ratio of the extraction regions AL3 and AR3 (such as setting the aspect ratio of 1:1, etc.), the aspect ratio may be changed instead.

Also, the extraction regions may be reduced in size rather than changing the aspect ratio in extracting the image data, and the size may be such that the extracted image data is expanded to a specific size.

(E) The above-mentioned interchangeable lens unit 200 may be a single-focus lens. In this case, the extraction centers ACL2 and ACR2 can be found by using the above-mentioned extraction position correction amount L11. If the interchangeable lens unit 200 is a single-focus lens, for example, the zoom lenses 210L and 210R may be fixed, in which case the zoom ring 213 and the zoom motors 214L and 214R need not be installed.

### INDUSTRIAL APPLICABILITY

The present invention can be applied to a camera body, an interchangeable lens unit, and an imaging device.

### REFERENCE SIGNS LIST

1 digital camera (an example of an imaging device)
15 signal processor
16 image extractor
17 image compressor
18 correction processor
100 camera body
110 CMOS image sensor (an example of an imaging element)
139 extraction position correction component
140 camera controller
140a CPU
140b ROM (an example of an angle storage component)
140c RAM
141 DRAM
142 identification information acquisition component
143 characteristic information acquisition component (an example of a correction information acquisition component)
144 camera-side determination component
145 state information acquisition component
146 lens detector
147 metadata production component
148 image file production component
149 region decision component
150 body mount
200 interchangeable lens unit
240 lens controller
240a CPU
240b ROM
240c RAM
241 DRAM
242 flash memory (an example of a correction information storage component)
243 state information production component
244 lens-side determination component
OL left-eye optical system
OR right-eye optical system
QL1 left-eye optical image
QR1 right-eye optical image
F1 lens identification information
F2 lens characteristic information
F3 lens state information
300 interchangeable lens unit
400 adapter
500 collimator lens
510 measurement-use camera body
520 measurement-use interchangeable lens unit
550 chart
600 interchangeable lens unit

1-5. (canceled)

6. An interchangeable lens unit configured to be mounted to a camera body having an imaging element, the interchangeable lens unit comprising:
a three-dimensional optical system configured to form a stereoscopic optical image of a subject; and
a correction information storage component configured to store an extraction position correction amount indicating a distance on the imaging element from a reference extraction position to a recommended extraction position, the reference extraction position corresponding to when a convergence point distance is infinity, the recommended extraction position corresponding to a recommended convergence point distance of the interchangeable lens unit.

7. The interchangeable lens unit according to claim 6, wherein
the correction information storage component is configured to store the recommended convergence point distance.

8. (canceled)

9. A method of controlling a camera body for producing image data based on an optical image formed by an interchangeable lens unit, the method comprising:
acquiring an extraction position correction amount from the interchangeable lens unit mounted to the body mount, the extraction position correction amount indicating a distance on an imaging element from a reference extraction position to a recommended extraction position, the reference extraction position corresponding to when a convergence point distance is infinity, the recommended extraction position corresponding to a recommended convergence point distance of the interchangeable lens unit.

10. The method of claim 9, further comprising:
correcting the reference extraction position to the recommended extraction position based on the extraction position correction amount.

11. The method of claim 9, further comprising:
acquiring lens identification information from the interchangeable lens unit mounted to the body mount, the lens identification information indicating whether or not the interchangeable lens unit is compatible with three-dimensional imaging; and
determining whether or not the interchangeable lens unit mounted to the body mount is compatible with three-dimensional imaging, based on the lens identification information, wherein
the determining whether or not the interchangeable lens unit mounted to the body mount is compatible with three-dimensional imaging includes acquiring the extraction position correction amount from the interchangeable lens unit when the camera-side determination component has determined that the interchangeable lens unit is compatible with three-dimensional imaging.

12. The method of claim 9, further comprising:
producing basic image data about the optical image formed on the imaging element by digitizing the image signal produced by the imaging element; and
deciding a first extraction region for extracting left-eye image data corresponding to at least part of a left-eye optical image, and a second extraction region for extracting right-eye image data corresponding to at least part of a right-eye optical image, the first extraction region and the second extraction region being used to extract part of the basic image data.

13. A program stored on a non-transitory computer-readable medium, the program for causing a computer to execute:
a correction information acquisition function for acquiring an extraction position correction amount from an interchangeable lens unit mounted to the body mount, the extraction position correction amount indicating a distance on an imaging element from a reference extraction position to a recommended extraction position, the reference extraction position corresponding to when a convergence point distance is infinity, the recommended extraction position corresponding to a recommended convergence point distance of the interchangeable lens unit.

14. The program of claim 13, the program further causing the computer to execute:
an extraction position correction function for correcting the reference extraction position to the recommended extraction position based on the extraction position correction amount.

15. The program of claim 13, the program further causing the computer to execute:
an identifying information acquisition function for acquiring lens identification information from the interchangeable lens unit mounted to the body mount, the lens identification information indicating whether or not the interchangeable lens unit is compatible with three-dimensional imaging; and
a camera-side determination function for determining whether or not the interchangeable lens unit mounted to the body mount is compatible with three-dimensional imaging, based on the lens identification information; wherein
the correction information acquisition component acquires the extraction position correction amount from the interchangeable lens unit when the camera-side determination component has determined that the interchangeable lens unit is compatible with three-dimensional imaging.

16. The program according to claim 13, the program further causing the computer to execute:
a signal processing function for producing basic image data about the optical image formed on the imaging element by digitizing the image signal produced by the imaging element; and
a region decision function for deciding a first extraction region for extracting left-eye image data corresponding to at least part of a left-eye optical image, and a second extraction region for extracting right-eye image data corresponding to at least part of a right-eye optical image, the first extraction region and the second extraction region being used to extract part of the basic image data.

17. A recording medium configured to be read by a computer, the recording medium recording a program for causing the computer to execute:
a correction information acquisition function for acquiring an extraction position correction amount from an interchangeable lens unit mounted to the body mount, the extraction position correction amount indicating a distance on an imaging element from a reference extraction position to a recommended extraction position, the reference extraction position corresponding to when a convergence point distance is infinity, the recommended extraction position corresponding to a recommended convergence point distance of the interchangeable lens unit.

18. The recording medium of claim 17, the recording medium recording a program for causing the computer to execute:
an extraction position correction function for correcting the reference extraction position to the recommended extraction position based on the extraction position correction amount.

19. The recording medium of claim 17, the recording medium recording a program for causing the computer to execute:
an identifying information acquisition function for acquiring lens identification information from the interchangeable lens unit mounted to the body mount, the lens identification information indicating whether or not the interchangeable lens unit is compatible with three-dimensional imaging; and
a camera-side determination function for determining whether or not the interchangeable lens unit mounted to the body mount is compatible with three-dimensional imaging, based on the lens identification information;
the correction information acquisition function for acquiring the extraction position correction amount from the interchangeable lens unit when the camera-side determination component has determined that the interchangeable lens unit is compatible with three-dimensional imaging.

20. The recording medium of claim 17, the recording medium recording a program for causing the computer to execute:
a signal processing function for producing basic image data about the optical image formed on the imaging element by digitizing the image signal produced by the imaging element; and
a region decision function for deciding a first extraction region for extracting left-eye image data corresponding to at least part of a left-eye optical image, and a second extraction region for extracting right-eye image data corresponding to at least part of a right-eye optical image, the first extraction region and the second extraction region being used to extract part of the basic image data.

21. A camera body for producing image data based on an optical image formed by an interchangeable lens unit, comprising:
a body mount configured to be attached to the interchangeable lens unit;
an imaging element configured to convert the optical image into an image signal; and
a correction information acquisition component configured to acquire an extraction position correction amount from the interchangeable lens unit mounted to the body mount, the extraction position correction amount indicating a distance on the imaging element from a reference extraction position to a recommended extraction position, the reference extraction position corresponding to when a convergence point distance is infinity, the recommended extraction position corresponding to a recommended convergence point distance of the interchangeable lens unit.

22. The camera body according to claim 21, further comprising
an extraction position corrector configured to correct a position of a used extraction region used for extracting the image data from the reference extraction position to the recommended extraction position, based on the extraction position correction amount.

23. The camera body according to claim 21, further comprising:
an identifying information acquisition component configured to acquire lens identification information from the interchangeable lens unit mounted to the body mount, the lens identification information indicating whether or not the interchangeable lens unit is compatible with three-dimensional imaging; and
a camera-side determination component configured to determine whether or not the interchangeable lens unit mounted to the body mount is compatible with three-dimensional imaging, based on the lens identification information,
the correction information acquisition component configured to acquire the extraction position correction amount from the interchangeable lens unit when the camera-side determination component has determined that the interchangeable lens unit is compatible with three-dimensional imaging.

24. The camera body according to claim 21, further comprising:
a signal processor configured to produce basic image data about the optical image formed on the imaging element by digitizing the image signal produced by the imaging element; and
a region decision component configured to decide a first extraction region for extracting left-eye image data corresponding to at least part of a left-eye optical image, and a second extraction region for extracting right-eye image data corresponding to at least part of a right-eye optical image, the first extraction region and the second extraction region being used to extract part of the basic image data.

25. The camera body according to claim 21, wherein
the region decision component decides the first extraction region and the second extraction region based on the recommended extraction position.

26. An imaging device, comprising:
the camera body according to claim 21; and
an interchangeable lens unit configured to be mounted to the camera body, the interchangeable lens unit comprising:
a three-dimensional optical system configured to form a stereoscopic optical image of a subject; and
a correction information storage component configured to store an extraction position correction amount indicating the distance on the imaging element from a reference extraction position to a recommended extraction position, the reference extraction position corresponding to when a convergence point distance is infinity, the recommended extraction position corresponding to a recommended convergence point distance of the interchangeable lens unit.
